(19) United States
(12) Patent Application Publication
(10) Pub. No.: US 2024/0337002 A1
(43) Pub. Date: Oct. 10, 2024

(54) A FeCrAl powder and an object made thereof

(71) Applicant: KANTHAL AB, Hallstahammar (SE)

(72) Inventors: Roger BERGLUND, Hallstahammar (SE); Johanna NOCKERT, Hallstahammar (SE)

(73) Assignee: KANTHAL AB, Hallstahammar (SE)

(21) Appl. No.: 18/707,687

(22) PCT Filed: Nov. 10, 2022
(86) PCT No.: PCT/SE2022/051053

§ 371 Date: May 6, 2024

(30) Foreign Application Priority Data
Nov. 11, 2021 (SE) 2130304-5

(51) Int. Cl. C22C 38/28; B22F 5/10; B22F 5/12; B22F 10/00; B33Y 10/00; B33Y 70/00; B33Y 80/00; C22C 38/00; C22C 38/06; C22C 38/26

(52) U.S. Cl. CPC C22C 38/28; B22F 5/106; B22F 5/12; B22F 10/00; C22C 38/001; C22C 38/002; C22C 38/06; C22C 38/26; B22F 2301/35; B33Y 10/00; B33Y 70/00; B33Y 80/00

(57) ABSTRACT

The present disclosure relates to a ferritic iron-chromium-aluminium (FeCrAl) powder of the following composition: Balance Fe and unavoidable impurities Al 4.0 to 6.0 Y max 0.20 Hf 0.05-0.20 O 0.01 to 0.03 Cr 19.0 to 23.0 Ta 0.05 to 0.30 Ti 0.01 to 0.10 C 0.01 to 0.05 N 0.01 to 0.10 Si Max 0.50 Mn Max 0.30 P Max 0.01 S Max 0.01 Zr 0.05 to 0.20 which will provide an object or an alloy thereof with excellent creep-strength.

### TECHNICAL FIELD The present disclosure relates to a ferritic iron-chromium-aluminum (FeCrAl) powder which will provide an object or an alloy thereof with excellent creep-strength.

### BACKGROUND

Iron-chromium-aluminum FeCrAl alloys, which are being manufactured from FeCrAl powders having a chromium (Cr) content of 15 to 25 wt % and an aluminum (Al) content from 3 to 6 wt %, are well known for their ability to form protective a-alumina (Al₂O₃), aluminum oxide scales, when exposed to temperatures between 900 and 1300° C. These alloys are therefore very useful in applications where there is a need for good oxidation resistance. However, even though said powders will provide products which will perform well in high temperature applications, there is always a need for a product with even higher creep resistance and better form stability as this will provide for longer service life.

It is therefore an aspect of the present disclosure to provide a FeCrAl powder which, when used for manufacturing an alloy or an object thereof, will provide these properties.

### SUMMARY

The present disclosure provides a ferritic iron-chromium-aluminum (FeCrAl) powder composition which has been optimized for providing an object with high creep-resistance. Furthermore, the present disclosure also provides an alloy or an object, wherein said object may be selected from a tube, a wire, a strip, a sheet, a heating element or a structural component, which has been manufactured from the power as defined below and therefore will exhibit excellent creep-strength and form stability. Furthermore, the powder of the present disclosure may be used in a conventional manufacturing process as well as in an additive manufacturing process. By the term “form stability” is meant that the object will essentially keep its form (shape) even though it is exposed to high temperature.

The iron-chromium-aluminium (FeCrAl) powder according to the present disclosure is characterized in that the powder has the following composition in weight % (wt %):

| | Fe and unavoidable |
|---|---|
| Balance | impurities |
| A | 4.0 to 6.0 |
| Y | max 0.20 |
| Hf | 0.05 to 0.20 |
| O | 0.01 to 0.03 |
| Cr | 19.0 to 23.0 |
| Ta | 0.05 to 0.30 |
| Ti | 0.01 to 0.10 |
| C | 0.01 to 0.05 |
| N | 0.01 to 0.10 |
| Si | Max 0.50 |
| Mn | Max 0.30 |
| P | Max 0.01 |
| S | Max 0.01 |
| Zr | 0.05 to 0.20 |

### DETAILED DESCRIPTION

The present disclosure relates to an iron-chromium-aluminium (FeCrAl) powder characterized in that the powder has the following composition (in weight %)

| | Fe and unavoidable |
|---|---|
| Balance | impurities |
| Al | 4.0 to 6.0 |
| Y | max 0.20 |
| Hf | 0.05 to 0.20 |
| O | 0.01 to 0.03 |
| Cr | 19.0 to 23.0 |
| Ta | 0.05 to 0.30 |
| Ti | 0.01 to 0.10 |
| C | 0.01 to 0.05 |
| N | 0.01 to 0.10 |
| Si | Max 0.50 |
| Mn | Max 0.30 |
| P | Max 0.01 |
| S | Max 0.01 |
| Zr | 0.05 to 0.20 |

The inventors have surprisingly found that by having a low content of yttrium and oxygen and not purposively adding any molybdenum, the present powder will, compared to conventional FeCrAl powders, provide an object with excellent creep resistance. This finding is very surprising as yttrium oxides are supposed to contribute to the creep strength and therefore the decrease of these elements should have led to a reduction in creep strength. However, for an object made of said powder, the creep strength has shown to increase.

The alloying elements of the present powder (and therefore for the alloy and the object(s)) will now be described in more detail. The terms “weight %” and “wt %” are used interchangeably. Also, the list of properties or contributions mentioned for a specific element should not be considered exhaustive.

### Iron (Fe)

The main function for iron is to balance the composition.

### Chromium (Cr) 19.0 to 23.0 wt %

Chromium is an important element since it will improve the corrosion resistance and increase the tensile and yield strength. Further, chromium facilitates the formation of the Al₂O₃ layer on the surface through the so-called third element effect, i.e. by formation of chromium oxide in the transient oxidation stage. Too low amount of chromium will result in loss of corrosion resistance. Thus, chromium shall be present an amount of at least 19.0 wt %, such as at least 20.0 wt %. Too much chromium will enable α to α′ decomposition and 475° C. embrittlement and will also lead to an increased solid solutioning hardening effect on the ferritic structure. Thus, the maximum content of chromium is set to 23.0 wt %, such as maximum 22.0 wt %. According to embodiments, the content of chromium is from 19.0 to 23.0 wt %, such as from 20.0 to 22.0 wt %.

### Aluminum (Al) 4.0 to 6.0 wt %

Aluminum is an important element since aluminum, when exposed to oxygen at high temperatures, will form a dense and thin Al₂O₃ layer on the surface, which will protect the underlying surface from further oxidation. Further, aluminum increases the electrical resistivity. At too low amounts of aluminum, there will be a loss of the ability for formation of Al₂O₃ layer and the electrical resistivity will be reduced. Thus, aluminum shall be present in an amount of at least 4.0 wt %, such as at least 4.5 wt %. Too high content of aluminum will cause brittleness at low temperatures and will also enhance the formation of unwanted brittle aluminides. Thus, the maximum aluminum is set to 6.0 wt %, such as maximum 5.5 wt %. According to embodiments, the Al content is 4.0 to 6.0 wt %, such as 4.5 to 5.5 wt %.

### Titanium (Ti) 0.01 to 0.10 wt %

Titanium is added in order to bind any free carbon or nitrogen. According to an embodiment, the content of Ti is from 0.01 to 0.06 wt %.

### Nitrogen (N) 0.01 to 0.10 wt %

Nitrogen is included to increase the strength by precipitation hardening. At too high levels, nitrogen may have a negative effect on the corrosion resistance. Therefore, the maximum amount of nitrogen is 0.10 wt %. According to the present disclosure, the content of N is from 0.01 to 0.10 wt %, such as 0.01 to 0.07 wt %.

### Zirconium (Zr) 0.05 to 0.20 wt %

Zirconium is an important element as zirconium will reduce the activity of C and N by the formation of ZrC or ZrN precipitates. Zirconium will also improve the high temperature creep strength of a manufactured object. Too low amount of Zr will increase the risk of the formation of unwanted chromium carbides and/or aluminum nitrides. Accordingly, zirconium shall be present in an amount of at least 0.05 wt %, such as at least 0.07 wt %, such as at least 0.10 wt %. On the other hand, too high content of zirconium may have a negative impact on the formation of Al₂O₃. For these reasons, the maximum content of zirconium is set to 0.20 wt %, such as maximum 0.15 wt %.

### Yttrium (Y) max 0.20 wt %

Yttrium is an optional element in the present powder. If added, it is added to improve the oxidation resistance of a manufactured object. However, if too much yttrium is added, this will cause hot embrittlement. As a result, the maximum content of yttrium content is set to maximum of 0.20 wt %, such as maximum 0.15 wt %.

### Carbon (C) 0.01 to 0.05 wt %

Carbon is added to increase strength by precipitation hardening. At too high levels, carbon may result in difficulties in forming due to the formation of chromium carbides and may also have a negative effect on the corrosion resistance. Therefore, the maximum amount of carbon in the inventive powder is 0.05 wt %.

### Silicon (Si) max 0.50 wt %

Silicon is present in levels of up to 0.50 wt % in order to increase electrical resistivity and to increase corrosion resistance. However, above this level, the hardness will increase and also there will be brittleness at low temperatures.

### Oxygen (O) 0.01 to 0.03 wt %

Oxygen is present in the form of oxides. The inventors have surprisingly found that that by lowering the oxygen content compared to conventional FeCrAl alloys, an object, which has been manufactured using the powder as defined hereinabove or hereinafter, will have very low creep rate and therefore it will also have high form stability. The maximum allowed content is 0.03 wt %. Thus, according to embodiments, the content of oxygen is from 0.01 to 0.03 wt %, such as from 0.01 to 0.02 wt %.

### Hafnium (Hf) 0.05 to 0.50 wt %

Hafnium is included in order to bind any free nitrogen or carbon, which otherwise would have a negative impact on the corrosion resistance. According to embodiments, the content of Hf is 0.05 to 0.50 wt %, such as 0.10 to 0.30 wt %, such as 0.10 to 0.20 wt %.

### Tantalum (Ta) 0.05 to 0.30 wt %

Tantalum is included in order to bind any free nitrogen or carbon, which otherwise have a negative impact on the corrosion resistance. According to embodiments, the content of each element is 0.05 to 0.30 wt %, such as 0.15 to 0.25 wt %.

### Mangan (Mn) max 0.30 wt %

Mangan is an optional alloying element. Too high content of Mn will interfere with the formation of the alumina layer. Accordingly, the content of Mn is set at maximum 0.30 wt %, such as such as maximum 0.20 wt %.

According to embodiments, the powder or the object may also include minor fractions of one or more of the following impurity elements such as but not limited to: Magnesium (Mg), Nickel (Ni), Cerium (Ce), Calcium (Ca), Phosphorus (P), Tungsten (W), Cobalt (Co), Sulphur (S), Molybdenum (Mo), Niobium (Nb), Vanadium (V) and Copper (Cu). By impurity elements are meant that they are present due to productions methods and/or material used in the manufacture process, but they are present in such small amounts that they do not affect the properties.

Additionally, the FeCrAl powder or FeCrAl object as defined hereinabove or hereinafter may comprise the alloying elements mentioned herein in any of the ranges mentioned herein. According to one embodiment, the present powder or object consists of all the alloying elements mentioned herein, in any of the ranges mentioned herein.

Moreover, the alloy or the object as defined hereinabove or hereinafter may comprise or consist of the alloying elements of the FeCrAl powder as defined hereinabove or hereinafter, in any of the ranges mentioned herein. The object obtained from the FeCrAl powder as defined hereinabove or hereinafter will operate well in high temperatures, such as up to 1250° C. Furthermore, the present object will have a significant high-temperature corrosion resistance and a high resistance against oxidation, sulphidation and carburization. Additionally, the object will have excellent high-temperature creep strength and form stability.

The present object may be selected from a tube or a strip or a sheet or a wire or a heating element or a structural component. The object is especially useful as an electrical heating element or as an object in high temperature applications.

The FeCrAl powder as defined hereinabove or hereinafter may be manufactured through different methods. For example, but not limited to:
directly by gas atomization;
heating a powder comprising all the alloying element in the ranges mentioned hereinabove or hereinafter;
mixing a powder comprising all the alloying element in the ranges mentioned hereinabove or hereinafter.

The invention is further described by the following non-limiting examples

### EXAMPLES

Three powders (Table 1) with the chemical composition in weight % according to Table 1 were produced using nitrogen gas atomization and then sieved to suitable fraction so that powders with particle size of less than 750 μm were obtained. Alloy 1 is an example of an inventive alloy within the ranges of the present disclosure, Alloy 2 and Alloy 3 are reference alloys.

TABLE 1
Composition of the powders

| | Alloy 1 | Alloy 2 | Alloy 3 |
|---|---|---|---|
| Element | Weight % | Weight % | Weight % |
| Al | 5.05 | 5.09 | 4.89 |
| C | 0.03 | 0.03 | 0.04 |
| Cr | 21.10 | 20.91 | 20.74 |
| Mn | 0.15 | 0.13 | 0.16 |
| N | 0.07 | 0.07 | 0.05 |
| Ni | 0.18 | 0.16 | 0.17 |
| O | 0.016 | 0.054 | 0.017 |
| P | 0.009 | 0.009 | 0.016 |
| Si | 0.32 | 0.32 | 0.32 |
| Zr | 0.11 | 0.12 | 0.12 |
| Mo | 0.02 | 3.05 | 2.95 |
| Ti | 0.03 | 0.02 | 0.04 |
| Nb | 0.01 | 0.02 | 0.01 |
| Co | 0.02 | 0.02 | 0.01 |
| V | 0.04 | 0.04 | 0.03 |
| Ta | 0.20 | 0.19 | 0.24 |
| Hf | 0.16 | 0.14 | 0.16 |
| Y | 0.15 | 0.17 | 0.03 |

Balance Fe and unavoidable impurities

The three powders (see Table 1) were HIP:ed with 3 h holding time at 1150° C. and 100 MPa pressure. As-HIP:ed sample pieces for mechanical testing was taken out and cylindrical extrusions billets with outer dimension Ø138×450 mm were machined. The extrusion billets were then hot extruded into tubes using conventional extrusion processes and sample pieces were taken from the extruded tubes.

Creep test specimens were machined from the as-HIP:ed and the extruded tube sample pieces. Creep testing was performed unaxially in air in order to find out the secondary creep rate, at 1100° C. and with 8.0 MPa tensile load. Table 2 shows the result of the creep testing. As can be seen from the result of Table 2, the creep strength of an object manufactured from the inventive powder will have a low secondary creep rate and a long time to rupture. Thus, an object made from a powder within the present invention will have good mechanical stability and will not be deformed at high temperatures when exposed to a load.

TABLE 2
The result of the creep strength

| | Time to | Secondary | |
|---|---|---|---|
| | rupture | creep rate | A |
| Sample | [h]: | [1/s]: | [%]: |
| Alloy 1 as-hipped | 528 | 7.84E−09 | 6.07 |
| Alloy 1 as extruded | 200 | 6.85E−08 | 12.73 |
| Alloy 2 as-hipped | 102 | 4.69E−08 | 6.96 |
| Alloy 2 as extruded | 33 | 1.04E−06 | 30.24 |
| Alloy 3 as-hipped | 191 | 9.19E−08 | 14.84 |
| Alloy 3 as extruded | 54 | 9.44E−07 | 34.62 |

1. A powder comprising the following elements in weight %

| | Fe and unavoidable |
|---|---|
| Balance | impurities |
| Al | 4.0 to 6.0 |
| Y | max 0.20 |
| Hf | 0.05-0.20 |
| O | 0.01 to 0.03 |
| Cr | 19.0 to 23.0 |
| Ta | 0.05 to 0.30 |
| Ti | 0.01 to 0.10 |
| C | 0.01 to 0.05 |
| N | 0.01 to 0.10 |
| Si | Max 0.50 |
| Mn | Max 0.30 |
| P | Max 0.01 |
| S | Max 0.01 |
| Zr | 0.05 to 0.20 |

2. The powder according to claim 1, wherein the content of Cr is from 20 to 22 wt %.

3. The powder according to claim 1, wherein the content of Y is max 0.16 wt %.

4. The powder according to claim 1, wherein the content of O is from 0.01 to 0.02 wt %.

5. The powder according to claim 1, wherein the content of Hf is from 0.10 to 0.20 wt %.

6. The powder according to claim 1, wherein the content of Ta is from 0.15 to 0.25 wt %.

7. The powder according to claim 1, wherein the content of Ti is from 0.01 to 0.05 wt %

8. The powder according claim 1, wherein the content of Zr is from 0.10 to 0.15 wt %.

9. An object or an alloy manufactured from the powder according to claim 1.

10. The object of claim 9, wherein said object is a tube or a strip or a wire or a heating element or a structural component.

11. The object according to claim 9, wherein said object has a secondary creep rate of less than 8.0E-09 [1/s] in HIP:ed condition when measured uniaxially with a 8.0 MPa load in air at 1100° C.

12. The object according to claim 9, wherein said object has a secondary creep rate of less than 7.0 E-08 [1/s] in hot extruded condition when measured uniaxially with a 8.0 MPa load in air at 1100° C.

13. The object according to claim 9, wherein the process for manufacturing said object includes an additive manufacturing step and/or a HIP step.
